(19) United States
(12) Patent Application Publication
(10) Pub. No.: US 2004/0196143 A1
(43) Pub. Date: Oct. 7, 2004

(54) Leveraging standard terminal emulation protocol as a connection mechanism for interfacing with RFID base stations

(76) Inventors: Bernie Crump, Cedar Rapids, IA (US); Craig Brophy, Cedar Rapids, IA (US)

Correspondence Address: Brian M. Berliner, O'MELVENY & MYERS LLP, 400 South Hope Street, Los Angeles, CA, 90071-2899, US

(21) Appl. No.: 10/814,423

(22) Filed: Mar. 30, 2004

Related U.S. Application Data
(60) Provisional application No. 60/459,877, filed on Apr. 1, 2003.

(51) Int. Cl. H04Q 5/22

(52) U.S. Cl. 340/10.1; 340/10.51; 235/462.01

(57) ABSTRACT

A system and method is provided for interfacing a radio frequency identification (RFID) device with a legacy terminal (i.e., an existing terminal). In one embodiment of the present invention, an RFID base station is adapted to interrogate an RFID transponder (tag) and a receiving terminal is adapted to communicate with the RFID base station using an RFID protocol and a legacy terminal using a standard terminal emulation protocol. In this embodiment, the base station is adapted to transmit (or receive) information to (or from) the tag. The information received is then transmitted to the receiving terminal, where it is provided to the legacy terminal via standard terminal emulation protocol. In another embodiment of the present invention, the legacy terminal is adapted to imbed (and the receiving terminal is adapted to recognized) “special” control characters in an emulation data string. By using “special” control characters (i.e., control characters that are recognizable by the receiving terminal), the legacy terminal is able to control the base station via the receiving terminal. In another embodiment of the present invention, the legacy terminal further includes a legacy application adapted to manipulate the information provided by the receiving terminal and/or request information from the receiving terminal. In this embodiment, the legacy application is adapted to imbed control characters into an emulation data string such that the receiving terminal recognizes the data string as being “special.”

### CROSS-REFERENCE TO RELATED APPLICATION

This application claims benefit pursuant to 35 U.S.C. § 119(e) of U.S. Provisional Application No. 60/459,877 filed Apr. 1, 2003, which application is specifically incorporated herein, in its entirety, by reference.

### BACKGROUND OF THE INVENTION

1. Field of the Invention

The present invention relates to radio frequency identification (RFID) devices, and more particularly to a system and method of interfacing an RFID device with a legacy terminal (i.e., an existing terminal) that utilizes a standard terminal emulation protocol.

2. Description of Related Art

Radio Frequency Identification (RFID) systems, which include RFID base stations and transponders (tags), are used in a variety of applications (e.g., inventory-control, security, etc.). Typically, an item including an RFID tag (e.g., a container with an RFID tag inside) is brought into a “read zone” established by the base station. The base station transmits an interrogating RF signal, which is modulated by either the base station or the RFID tag. Specifically, the base station provides (or writes) information to the tag by transmitting a modulated electromagnetic disturbance at a particular carrier frequency, and receives (or reads) information from the tag by transmitting a continuous wave electromagnetic disturbance. The tag then modulates the continuous RF signal in order to impart information (e.g., information stored within the tag) into the signal. The modulated RF signal is reflected back to the base station where the imparted information is extracted.

Incorporating an RFID system into a legacy identification system (i.e., an existing identification system), however, can be expensive and time consuming. For example, many companies (e.g., factories, warehouses, etc.) currently utilize barcoding systems to identify items. Such systems typically include applications (i.e., legacy applications) operating on or in conjunction with terminals (i.e., legacy terminals), barcode readers and barcodes. Specifically, barcode readers are used to read barcodes attached to items. The information acquired by the barcode readers is then provided to the legacy terminals, where it is manipulated (e.g., processed, stored, displayed, etc.) by the legacy applications.

One drawback of such a system is that a typical legacy terminal, or more specifically the communication protocol used by typical legacy terminals (i.e., standard terminal emulation protocol), is not compatible with traditional RFID base stations. Furthermore, RFID terminals (which are compatible with traditional RFID base stations) may not be capable of manipulating information in a desirable manner (e.g., in the same manner as the legacy applications). Thus, companies interested in switching to, or testing, an RFID system may have to either abandon the manner in which information is manipulated (i.e., abandon their legacy applications) or expend a significant amount of time and money to design a terminal that will (i) communicate with RFID base stations and (ii) operate their legacy applications. These drawbacks can dissuade a company from switching to, or testing, an RFID system even if the company would otherwise benefit from using such a system.

Thus, it would be advantageous to provide a system and method of interfacing an RFID base station with a legacy terminal that utilizes standard terminal emulation protocol.

### SUMMARY OF THE INVENTION

The present invention provides a system and method of interfacing an RFID base station with a legacy terminal (i.e., an existing terminal) that utilizes standard terminal emulation protocol. In one embodiment of the present invention, an RFID system includes an RFID tag, an RFID base station, a legacy terminal and a receiving terminal, where the RFID base station is adapted to interrogate the RFID tag, and the receiving terminal (which communicates with the RFID base station) is adapted to communicate with the legacy terminal via standard terminal emulation protocol. Specifically, the base station is adapted to transmit (or receive) information to (or from) the tag. The information received is then transmitted to the receiving terminal, where it is provided to the legacy terminal via standard terminal emulation protocol. In one embodiment of the present invention, the legacy terminal is adapted to imbed (and the receiving terminal is adapted to recognize) “special” control characters in an emulation data string. By using “special” control characters (i.e., control characters that are recognizable by the receiving terminal), the legacy terminal is able to control the base station via the receiving terminal. In other words, the receiving terminal (in general) acts as an intermediary between the legacy terminal and the base station.

In another embodiment of the present invention, the legacy terminal further includes a legacy application (i.e., an existing application) adapted to manipulate the information provided by the receiving terminal and/or request information from the receiving terminal. Specifically, the legacy application is adapted to imbed control characters into an emulation data string such that the receiving terminal recognizes the data string as being “special.”

In either embodiment, the types of control characters that may be imbedded into an emulation data string include, but are not limited to, port-initialization commands, barcode-scanning commands, RFID-reading commands (e.g., identify all tags, read all tags, read a specific tag, etc.), and RFID-writing commands (e.g., write to all tags, write to a specific tag, etc.). For example, certain control characters imbedded into an emulation data string may result in the receiving terminal performing a particular action (e.g., initializing its I/O port, instructing the base station to scan a barcode, instructing the base station to identify RFID tags, instructing the base station to read one (or all) RFID tag(s), instructing the base station to write data to one (or all) RFID tag(s), etc.).

One method of interfacing a legacy terminal adapted to communicate via standard terminal emulation protocol with an RFID base station is to (i) modify a legacy terminal to imbed information (e.g., control characters) into an emulation data string, (ii) modify a receiving terminal to recognize the emulation data string as “special,” (iii) parse and interpret the information imbedded in the emulation data string, and (iv) execute at least one action in response to the imbedded information.

A more complete understanding of the system and method of interfacing an RFID base station with a legacy terminal that utilizes standard terminal emulation protocol will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a conceptual block diagram of an RFID system including a terminal, a base station and an RFID tag;

FIG. 2 is a conceptual block diagram of an RFID system operating in accordance with one embodiment of the present invention.

FIG. 3 illustrates one embodiment of imbedding information into an emulation data string.

FIG. 4 is a flow chart illustrating one embodiment of the present invention; and

FIG. 5 is a flow chart illustrating another embodiment of the present invention.

### DETAILED DESCRIPTION OF THE PREFERRED EMBODIMENT

The present invention provides a system and method of interfacing an RFID base station with a terminal that utilizes standard terminal emulation protocol. In the detailed description that follows, like element numerals are used to describe like elements illustrated in one or more figures.

A traditional RFID system 100 is illustrated in the conceptual block diagram of FIG. 1, including a RFID terminal 130, an RFID base station 120 and an RFID tag 110. Specifically, the base station 120 is adapted to write (or read) information to (or from) the tag 110. More particularly, the base station 120 (e.g., at the request of the terminal 130) writes information to the tag by transmitting a modulated electromagnetic disturbance at a particular carrier frequency. Furthermore, the base station 120 (e.g., at the request of the terminal 130) reads information from the tag 110 by transmitting a continuous wave electromagnetic disturbance. The tag 110 then modulates the continuous RF signal in order to impart Information (e.g., information stored within the tag 110) into the signal. The modulated RF signal is reflected back to the base station 120 where the imparted information is extracted. Once extracted, the information can be provided to the terminal 130 for further manipulation (e.g., processing, storing, displaying, etc.).

One drawback of the traditional RFID system (e.g., 100), however, is that an RFID base station (e.g., 120), or more particularly the communication protocol used by base stations, may not be compatible with terminals (i.e., legacy terminals) used in non-RFID systems (e.g., barcode system terminals, etc.). This is because legacy terminals typically communicate via standard terminal emulation protocol, as opposed to RFID base stations, which typically communicate via a unique RFID protocol. It should be appreciated that the term “legacy” (e.g., legacy terminal, legacy application) is used herein in its broad sense to include terminals and/or applications that are already owned and/or used by a company, or terminals and/or applications that can be purchased for use in non-RFID identification systems. It should further be appreciated that the term “standard terminal emulation protocol” is also used herein in its broad sense to include all terminal emulation protocols generally known to those skilled in the art.

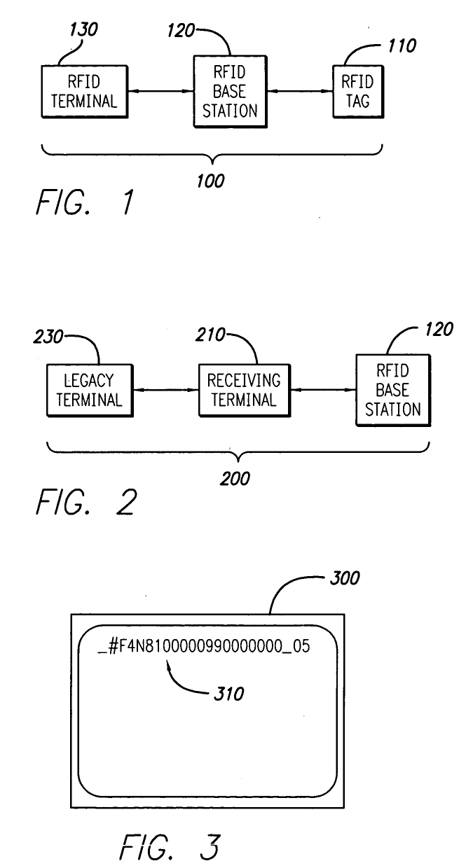

An RFID system 200 operating in accordance with one embodiment of the present invention is illustrated in the conceptual block diagram of FIG. 2. Specifically, an RFID base station 120 is adapted to transmit (or receive) information to (or from) an RFID tag (not shown). The information received is then transmitted to a receiving terminal 210, where it is provided to a legacy terminal 230 adapted to communicate via a standard terminal emulation protocol. Thus, the receiving terminal 210 is acting (generally) as an intermediary between the legacy terminal 230 and the base station 120. It should be appreciated that the terminals depicted in FIG. 2 (i.e., 210, 230) include, but are not limited to, terminal emulators, processors, personal computers, programmable logic controllers (PLCs) and all other intelligent devices capable of communicating (or being adapted to communicate) via a standard terminal emulation protocol known to those skilled in the art. It should further be appreciated that the RFID base station depicted in FIG. 2 (i.e., 120) is not limited to a base station adapted to communicate solely with RFID tags. For example, an RFID base station that is further adapted to scan barcodes, or receive information from a barcode scanner, is within the spirit and scope of the present invention. It should also be appreciated that the components depicted in FIG. 2 (i.e., 120, 210 and 230) are not limited to any particular method of transmitting/receiving information. Therefore, transmitting/receiving information via a communication line that is hardwired (e.g., a serial port, parallel port, LAN, WAN, fiber-optic cable, etc.) or wireless is within the spirit and scope of the present invention.

In one embodiment of the present invention, the legacy terminal 230 may further include a legacy application (i.e., an existing application operating on or in conjunction with the legacy terminal 230) adapted to manipulate the information provided by the receiving terminal 210 and/or request information from the receiving terminal 210. Specifically, the legacy terminal 230 (or the legacy application (not shown)) is adapted to imbed control characters into an emulation data string such that the receiving terminal 210 recognizes the data string as being “special.” The types of control characters that may be imbedded into an emulation data string include, but are not limited to, port-initialization commands, barcode-scanning commands, RFID-reading commands (e.g., identifying all tags, read all tags, read a specific tag, etc.), and RFID-writing commands (e.g., write to all tags, write to a specific tag, etc.).

One example of control characters being imbedded into an emulation data string 310 is illustrated in FIG. 3. For illustrational purposes, the data string 310 is depicted as if it were being displayed on a terminal emulator 300. From this it can be seen how the data string 310 is identifying itself as being “special” (i.e., “special” to the receiving terminal). Specifically, instead of beginning on line one, column one, the data string 310 begins on line one, column two. It should be appreciated, however, that the present invention is not limited to this one method of identifying a data string as “special,” but includes all methods (e.g., using unique or identifiable characters, placement, timing, etc.) generally known to those skilled in the art.

Referring back to FIG. 3, the illustrative control characters are used to initialize a serial port on the receiving terminal. The serial port is then used to communicate with the RFID base station (see FIG. 2). Specifically, the “#F” command indicates that the receiving terminal is to communicate with the RFID base station. The remaining characters are then used to initialize the serial port. For example, the “4N” indicates the serial port's baud rate (e.g., 1=1200, 2=2400, 3=4800, 4=9600, 5=19200, 6=38400, etc.) and parity (e.g., N=no, E=even, O=odd), respectively. The “81” indicates the number of data bits (e.g., seven, eight, etc.) and the number of stop bits (e.g., one, two, etc.), respectively. The following five zeros indicate that CTS flow is disabled, DTR flow is disabled, XOFF flow control is disabled, and a zero second timeout value is used for flow control response (i.e., a two-bit value), respectively. The following two digits (i.e., 99) indicate the maximum number of characters that can be received via the serial port, and the following seven zeros signify that there is no delimiter character (i.e., a two-bit value), the number of delimiter characters that will be received is zero (i.e., a two-bit value), there is no start character (i.e., a two-bit value), and the flag indicating that the start character is to be returned to the legacy terminal is disabled, respectively. The following blank indicates that the parity flag is disabled (e.g., blank=disabled, P=enabled, etc.), and the following two characters (i.e., the twenty-third and twenty-fourth characters) are used to specify the number of seconds the receiving terminal will wait to receive information from the base station (i.e., receiving timeout data).

It should be appreciated, however, that the data string provided in FIG. 3 (i.e., 310) is not intended to limit the present invention, but only to provide an example of how the present invention operates. Thus, for example, imbedding control characters that are different in number and/or type, or correspond to the taking of a different action (e.g., transmitting information to the base station), are within the spirit and scope of the present invention. For example, certain control characters may result in having commands transmitted (via the receiving terminal) to the RFID base station. These commands include, but are not limited to, having the base station (i) scan barcodes (or receive information from a barcode scanner), (ii) identify RFID tags, (iii) read a specific RFID tag, (iv) read all RFID tags, (v) write data to a specific RFID tag, (vi) write data to all RFID tags, (vii) etc. In one embodiment of the present invention, the commands may be more detailed in nature. For example, the commands may include, but are not limited to, having the base station (i) read an RFID tag having a specific tag ID, starting at a specific address and for a specific length (RT\hat{ }tagid\hat{ }StartAddr\hat{ }Length), (ii) read all RFID tags starting at a specific address and for a specific length (RA\hat{ }StartAddr\hat{ }Length), (iii) write data to all RFID tags starting at a specific address and for a specific length (WA\hat{ }StartAddr\hat{ }Lentgh\hat{ }Data), (iv) write data to a specific RFID tag having a specific tag ID, starting at a specific address and for a specific length (WT\hat{ }Tagid\hat{ }StartAddr\hat{ }Length\hat{ }Data), etc. In one embodiment of the present invention, control characters corresponding to base station commands are imbedded immediately after control characters corresponding to port-initialization (e.g., 310). In other words, the control characters immediately following the port-initialization portion of the data string (also known as the “header”) are used to control the RFID base station (e.g., transmitted to the RFID base station).

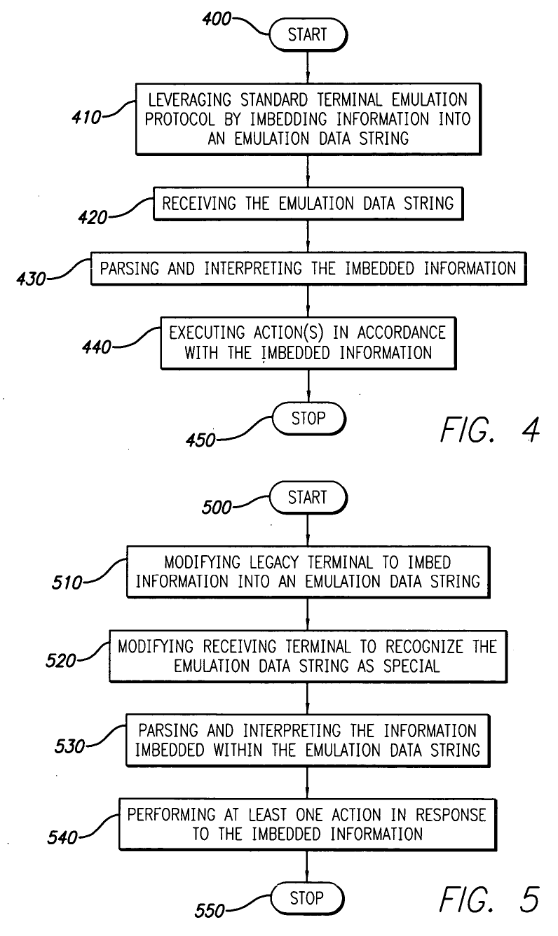

One method of interfacing a first terminal adapted to communicate via standard terminal emulation protocol with an RFID base station, or more particularly a second terminal in communication with an RFID base station is illustrated in FIG. 4. Specifically, starting at step 400, the standard terminal emulation protocol of a first terminal is leveraged by imbedding information (e.g., control characters) into an emulation data string at step 410. At step 420, a second terminal in communication with an RFID base station receives the emulation data string. The second terminal, at step 430, then parses and interprets the imbedded information. The interpreted action (e.g., initializing a port, transmitting information to the base station, etc.) is then executed by the second terminal at step 440, completing the method at step 450.

One method of interfacing a legacy terminal adapted to communicate via standard terminal emulation protocol with a receiving terminal is illustrated in FIG. 5. Specifically, starting at step 500, the legacy terminal (or a legacy application operating on or in conjunction with the legacy terminal) is modified to imbed information (e.g., control characters) into an emulation data string at step 510. The receiving terminal is then modified to recognize the emulation data string as “special.” For example, this may require activating an extended command configuration parameter in the receiving terminal's menu set. At step 530, the receiving terminal parses and interprets the information imbedded in the emulation data string. The receiving terminal, at step 540, then executes at least one action in response to the imbedded information, completing the method at step 550.

Having thus described embodiments of a system and method of interfacing an RFID base station with a legacy terminal (i.e., an existing terminal) that utilizes standard terminal emulation protocol, it should be apparent to those skilled in the art that certain advantages of the system have been achieved. It should also be appreciated that various modifications, adaptations, and alternative embodiments thereof may be made within the scope and spirit of the present invention. The invention is further defined by the following claims.

1. A method of interfacing a terminal with a radio frequency identification (RFID) base station, comprising:
transmitting a data string from said terminal using a standard terminal emulation protocol, wherein said data string is recognizable as including RFID information;
receiving said data string;
identifying said data string as including RFID information;
using said data string to produce an RFID signal that includes said RFID information; and
transmitting said RFID signal to said RFID base station using an RFID protocol.

2. The method of claim 1, further comprising:
receiving a responsive RFID signal from said RFID base station using said RFID protocol, wherein said RFID signal includes transponder information that is responsive to said RFID information;
using said responsive RFID signal to produce a responsive data string that includes said transponder information;
transmitting said responsive data string to said terminal using said standard terminal emulation protocol.

3. The method of claim 1, wherein said step of transmitting a data string from said terminal further comprises inserting characters into said data string to make said data string recognizable as including RFID information;

4. The method of claim 1, wherein said step of identifying said data string as including RFID information further comprises identifying at least the location of a first character in said data string to determine whether said data string includes said RFID information.

5. The method of claim 1, wherein said step of using said data string to produce an RFID signal further comprises parsing said data string into identifiable character sets, interpreting said character sets into said RFID information, and compiling said RFID signal to include said RFID information;

6. The method of claim 1, further comprising the step of using said RFID information to communicate with at least one RFID transponder.

7. The method of claim 1, further comprising the step of using said RFID information to communicate with at least one barcode scanner.

8. The method of claim 1, wherein said RFID information is selected at least in part from a list of information consisting of a port-initialization command, barcode-scanning command, RFID-reading command, RFID-writing command, and RFID data.

9. The method of claim 8, wherein said RFID-reading and RFID-writing commands are selected from a list of commands consisting identify-all-transponders, read-all-transponders, read-specific-transponders, write-to-all-transponders, and write-to-specific-transponders.

10. A radio frequency identification (RFID) system, comprising:
an RFID base station adapted to communicate with at least one RFID transponder; and
a first terminal electrically connected to said RFID base station and a second terminal, said first terminal adapted to:
communicate with said RFID base station using an RFID protocol;
communicate with said second terminal using a standard terminal emulation protocol,
receive a plurality of data strings from said second terminal,
wherein a portion of said plurality of data strings are directed toward said RFID base station and include RFID information;
identify said portion of said plurality of data strings;
use said RFID information and said RFID protocol to generate at least one RFID signal; and
transmit said at least one RFID signal to said RFID base station.

11. The RFID system of claim 10, wherein said RFID base station is further adapted to communicate with a barcode scanner.

12. The RFID system of claim 10, wherein said RFID base station is further adapted to scan barcodes.

13. The RFID system of claim 10, wherein said RFID information is selected from a list of information consisting of port-initialization command, barcode-scanning command, RFID-reading command, RFID-writing command, RFID data.

14. The RFID system of claim 10, wherein said first terminal is adapted to identify said portion of said plurality of data strings by identifying character indicia, said character indicia being selected from a list consisting of character type and first-character location.

15. The RFID system of claim 10, further comprising:
said second terminal; and
an application operating thereon, said application being adapted to embed characters into a data string so that said data string is recognizable by said first terminal as being directed toward said RFID base station.

16. A radio frequency identification (RFID) system for communicating with an RFID base station; comprising:
a terminal adapted to:
receive a plurality of data signals, wherein each one of said plurality of data signals is compiled according to a standard terminal emulation protocol’
identify at least one of said plurality of data signals that is directed toward an RFID base station, said at least one of said plurality of data signals including a first set of information that corresponds to at least one action that is to be performed by said RFID base station;
generating a data signal compiled according to an RFID protocol and including a second set of information that corresponds to said first set of information; and
transmitting said data signal to said RFID base station.

17. The RFID system of claim 16, wherein said first set of information is at least substantially the same as said second set of information.

18. The RFID system of claim 16, wherein said terminal is further adapted to receive said plurality of data signals from another terminal.

19. The RFID system of claim 16, wherein said first and second sets of information correspond to a barcode-scanning action that is to be performed by said RFID base station.

20. The RFID system of claim 16, wherein said first and second sets of information correspond to an RFID action that is to be performed by said RFID base station, said RFID action being selected from a list of action consisting of initializing a port of said RFID base station, reading RFID data from at least one RFID transponder, and writing RFID data to at least one RFID transponder.
